(19) United States
(12) Patent Application Publication
(10) Pub. No.: US 2006/0282198 A1
(43) Pub. Date: Dec. 14, 2006

(54) Intelligent chassis mechanism capable of detecting strain

(75) Inventor: Huan-Lung Gu, Hsinchu County (TW)

Correspondence Address: BACON & THOMAS, PLLC, 625 SLATERS LANE, FOURTH FLOOR, ALEXANDRIA, VA, 22314, US

(73) Assignee: INDUSTRIAL TECHNOLOGY RESEARCH INSTITUTE, HSINCHU HSIEN (TW)

(21) Appl. No.: 11/252,756

(22) Filed: Oct. 19, 2005

(30) Foreign Application Priority Data
Jun. 10, 2005 (TW) 94119413

(51) Int. Cl. G06F 17/00

(52) U.S. Cl. 701/1; 702/42

(57) ABSTRACT

An intelligent chassis mechanism incorporated into a vehicle includes a plurality of stress-strain sensors installed in the chassis of the vehicle at different locations for detecting the direction and amount of any strain occurred thereon to enable the chassis mechanism to be a large strain-detecting unit. The intelligent chassis mechanism can be combined with microprocessor artificial intelligent technology to detect how much strain the vehicle takes and to provide the detected data to the microcomputer system of the vehicle.

### BACKGROUND OF THE INVENTION

1. Field of the Invention

The present invention relates to artificial intelligent technology and more particularly, to the application of a microcomputer technology to incorporate an intelligent chassis mechanism capable of detecting strain thereof into a vehicle.

2. Description of the Related Art

A vehicle is a well-developed public transportation means having more than one hundred years' history. Following fast development of modern technology and civilization, different intelligent vehicles of different shapes and functions have been developed. These intelligent vehicles are the combination of mechanics and microcomputer technology. The chassis is the main structure of a vehicle that supports the whole vehicle system. Till the present time, there is no any breakthrough design of chassis been created.

With respect to strain detection, U.S. Pat. No. 3,934,663, entitled “Attachment device for a gauge”, teaches the use of sensor means under the driver's seat to detect the driver's weight, or in a measuring means to measure the vehicle weight. This conventional technique does not take the chassis characteristics into account, therefore it is unable to fully carry out the detecting function of a stress or strain sensor or to make the vehicle intelligent.

Therefore, it is desirable to provide an intelligent vehicle that combines artificial intelligent technology to give a quick response to any variation of stress and to detect the parameters of the vehicle, such as vehicle weight, tire pressure, impact, temperature, wheel alignment, and etc.

### SUMMARY OF THE INVENTION

The present invention has been accomplished under the circumstances in view. It is therefore the main object of the present invention to provide an inexpensive intelligent chassis mechanism, which combines microprocessor artificial intelligent technology to detect any force worked on the vehicle.

It is another object of the present invention to provide an intelligent vehicle, which combines a microcomputer artificial intelligent technology to detect the direction and amount of any strain occurred on the vehicle for feedback of the detected result to the microcomputer system of the vehicle.

To achieve these objects of the present invention, the intelligent chassis is incorporated into a vehicle, comprising a chassis body, and at least one stress-strain sensor. The chassis body comprises at least one wheel bracket, at least one wheel rotatably fastened to the at least one wheel bracket to bear the weight of the vehicle. The at least one stress-strain sensor is installed in the at least one wheel bracket for detecting the amount and direction of a strain occurred thereon so as to provide to the microcomputer system of the vehicle a respective strain data indicative of the amount and direction of the strain detected.

### BRIEF DESCRIPTION OF THE DRAWINGS

FIG. 1 is a schematic view of a four-wheel vehicle constructed according to a first preferred embodiment of the present invention.

FIG. 2 is a schematic top view of FIG. 1.

FIG. 3 is a circuit block diagram of the first preferred embodiment of the present invention.

FIG. 4 is a schematic drawing showing the structure of the detecting circuit of the stress-strain sensor according to the first preferred embodiment of the present invention.

FIG. 5 is a circuit block diagram of a second preferred embodiment of the present invention.

FIG. 6 is a schematic drawing showing the structure of the detecting circuit of the stress-strain sensor according to the second preferred embodiment of the present invention.

### DETAILED DESCRIPTION OF THE INVENTION

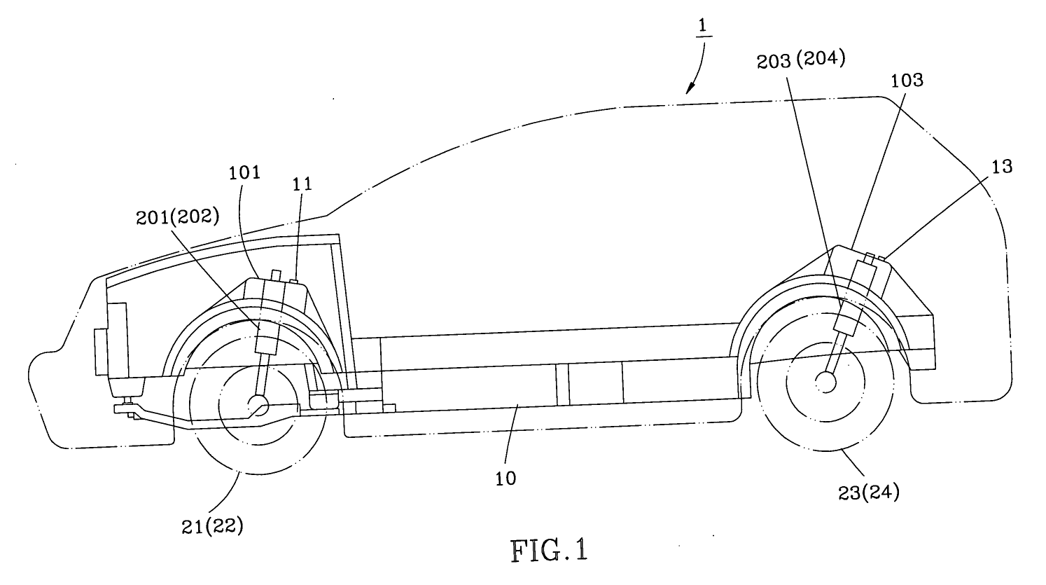

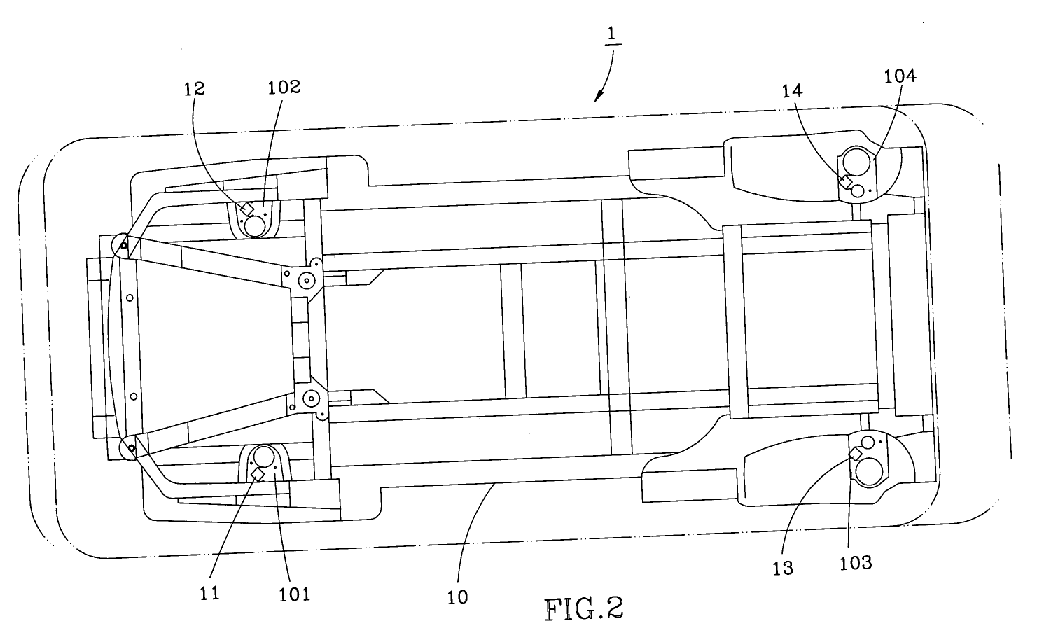

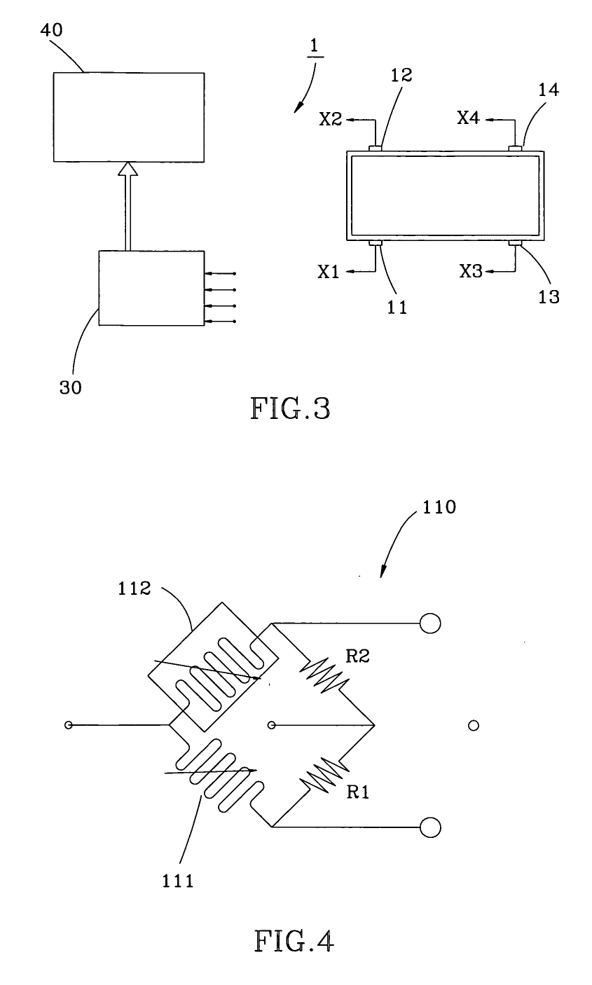

Referring to FIGS. 1 and 2, an intelligent vehicle 1 in accordance with a first preferred embodiment of the present invention comprises a chassis 10. The chassis 10 comprises four support frames 101, 102, 103 and 104, four wheel brackets 201, 202, 203 and 204 respectively mounted on the support frames 101, 102, 103 and 104, and four wheels 21, 22, 23 and 24 respectively rotatably supported on the wheel brackets 201, 202, 203 and 204. Through the wheel brackets 201, 202, 203 and 204, the wheels 21, 22, 23 and 24 support the total weight of the vehicle. Stress-strain sensors 11, 12, 13 and 14 are respectively installed in the support frames 101, 102, 103 and 104, enabling the chassis 10 itself to work as a big scale strain detector. When the chassis 10 is in a stable condition to receive reactive force from the wheels 21, 22, 23 and 24, the stress-strain sensors 11, 12, 13 and 14 rapidly respond to the amount of strain of this stable condition and transmit a respective strain data X1, X2, X3 or X4 to a microprocessor 30 through a wireless transmission method, as shown in FIG. 3.

Referring to FIG. 4, the stress-strain sensor 11 comprises a detecting circuit 110, which is a Wheatstone Bridge circuit comprised of first variable resistor formed of a strain meter 111, a second variable resistor formed of a temperature compensation strain meter 112, and two fixed resistors R1 and R2. The temperature compensation strain meter 112 is installed in a detection base of same material as the chassis 10 so that the temperature compensation strain meter 112 can compensate for the amount of deformation caused by the surrounding temperature at the detecting circuit 110. Therefore, the stress-strain sensor 11 is free from the influence of the surrounding temperature and can accurately detect the amount of deformation of the chassis 10 around the area at which it is located. The other stress-strain sensors 12, 13 and 14 are made in the same manner. Therefore the stress-strain sensors 11-14 each provide a respective strain data X1, X2, X3 or X4 corresponding to the respective location to the microprocessor 30 for further calculation and recording.

When the vehicle is in a stable condition, the detecting points each provide a respective reference strain data X1, X2, X3 or X4, i.e., the respective initial value. When the chassis 10 is in a different temperature condition and carrying a different load, the detecting points respectively provide another strain data X1′, X2′, X3′ or X4′. Upon receive of this set of stain data X1′, X2′, X3′ and X4′, the microprocessor 30 compares the data with the storage reference stain data X1, X2, X3 and X4, and then calculate the difference so as to obtain the amount of deformation and to output the calculation result to a display monitor 40 for display, enabling the user to know the message.

In an example of a particular model of vehicle, when the total weight of the vehicle is transmitted to the stress-strain sensors 11, 12, 13 and 14 through the support frames 101, 102, 103 and 104 of the chassis 10, the stress-strain sensors 11, 12, 13 and 14 each provide a respective reference strain data X1, X2, X3 or X4 in response to the total weight of the vehicle for use as the respective initial value. When the total weight of the vehicle changed, the stress-strain sensors 11, 12, 13 and 14 each provide a respective different strain data X1′, X2′, X3′ or X4′ in response to this change. This amount of variation at each detecting point is recorded so as to form a set of standard weight-strain data for this vehicle model, and a table of weight-strain data is then built in the microprocessor 30. Thus, an intelligent product is provided for use to indicate the weight of this vehicle model at whatever time.

In an example of local variation of weight where the weight of the vehicle is not evenly distributed through the wheels 21, 22, 23 and 24 but biased against a specific detecting point, the amount of variation at such a specific location will be relatively greater during detection, and the other detecting points will show a respective strain mode of different proportion of amount of deformation. By means of this strain mode, the distributed of the increased weight is measured. Therefore, the chassis 10 can be used to measure the distribution of weight of the vehicle at different locations. A regular strain sensor has a directional limitation, i.e., the stress-strain sensors 11, 12, 13 and 14 can only accurately detect the amount of strain in a particular direction. In order to detect the amount of deformation in different directions accurately, it is suggested to install a number of stress-strain sensors at every detecting point in different directions. Therefore, three stress-strain sensors can be installed in each of the support frames 101, 102, 103 and 104 in X, Y and Z directions to form a Cartesian coordinate system, enhancing the accurate strain detection functioning of the chassis 10.

With respect to the variation of tire pressure, when the tire pressure is low, a variation of bearing angle at every wheel 21, 22, 23 or 24 relative to the respective support frame 101, 102, 103 or 104 will be measured by the respective stress-strain sensors 11, 12, 13 or 14, therefore the vehicle 1 has the function of indicting the insufficient status of tire pressure.

With respect to the wheel alignment function, when the wheels are not kept in balance, i.e., the wheels 21, 22, 23 and 24 are not well aligned, the two opposite lateral sides of the chassis 10 will be forced to produce a certain extent of deformation by the asymmetric force received from the support frames 101, 102, 103 and 104, therefore another type of strain mode will be produced at every detecting point. By means of the multi-point detection of the stress-strain sensors 11, 12, 13 and 14, the wheel alignment status of the chassis 10 is detected.

With respect to impact detection, when one side of the body of the vehicle is slowly pressed by an external force to show a status similar to increase of local vehicle weight, however due to the existence of sideway component of force of vehicle weight, the strain mode produced by each of the stress-strain sensors 11, 12, 13 and 14 will be different from the strain mode produced by the stress-strain sensor due to increase of vehicle weight, therefore a stain mode of oppression at a particular point is detected. If the impact is a transient pressure to the vehicle, it can easily be detected. When encountered a road impact during running of the vehicle on the road, a transient variation of impact force will be produced, at this time the wheel(s) suspending in the air will provide a pull force to the chassis 10, thereby causing a specific strain mode to be produced for recognition of the occurrence of the road impact.

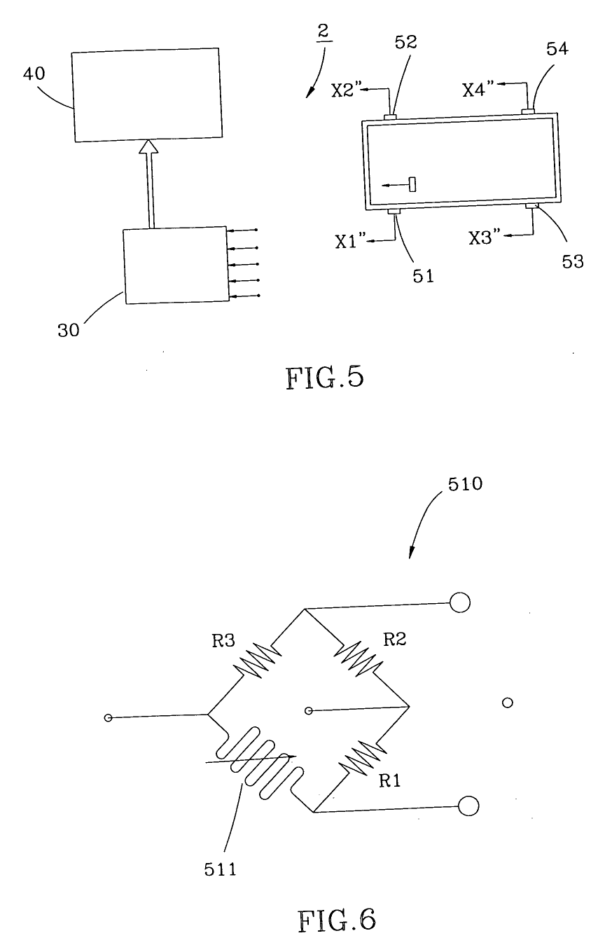

With respect to temperature compensation function, the invention provides a second embodiment. The intelligent vehicle 2 according to this second embodiment as shown in FIG. 5, is substantially similar to the aforesaid first embodiment. The chassis 10 of the intelligent vehicle 2 comprises stress-strain sensors 51, 52, 53 and 54 respectively mounted on the support frames 101, 102, 103 and 104, and a temperature-strain meter 55 that produces a strain mode subject to the variation of surrounding temperature. According to this embodiment, the stress-strain sensors 51, 52, 53 and 54 do not provide a temperature compensation function. FIG. 6 shows the structure of the detecting circuit 510 of one stress-strain sensor 51. The detecting circuit 510 is a Wheatstone bridge circuit comprised of a strain meter 511 formed of a variable resistor, and three fixed resistors R1, R2 and R3. The detection circuit 510 responds to the amount of deformation under the current temperature. The other three sets of stress-strain sensors 52, 53 and 54 have the same structure. Therefore, the stress-strain sensors 51-54 produce respective strain data X1″, X2″, X3″and X4″ containing an effect of temperature. The temperature-strain meter 55 is adapted to detect the amount of deformation produced at the vehicle due to the change of surrounding temperature, thereby producing a strain data X5″ for temperature compensation, therefore, when compared with the reference data built in the microprocessor 30, the stress-strain sensors 51, 52, 53 and 54 accurately respond to the influence of the variation of temperature at the respective detecting point to the chassis 10, and the variation value of the chassis affected by the surrounding temperature is measured.

Therefore, the user can know the variation of total weight of the vehicle, the variation of weight at a specific location in a specific direction, the variation of tire pressure of one specific wheel, the condition of an oppression (for example, impact) at one side of the vehicle, an unbalanced status of the wheels, or the variation of outside temperature at whatever time. Therefore, an intelligent vehicle made according to the present invention can detect various conditions and send the detected data to a microprocessor for processing, enabling the calculated result to be displayed on a display monitor, i.e., the invention enables a vehicle to become an intelligent machine.

The aforesaid strain meter 111 can be a piezo meter formed of a piezoelectric crystal that achieves the same stress and strain detection function. Further, a wired communication line may be installed and electrically connected between the stress-strains sensors and the microprocessor 30 to substitute for the aforesaid wireless communication method. Further, the invention is applicable to any of a variety of vehicles that carries a microprocessor.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An intelligent chassis mechanism incorporated into a vehicle, comprising:
a chassis body having at least one wheel bracket and at least one wheel rotatably fastened to said at least one wheel bracket for bearing the weight of the vehicle;
at least one stress-strain sensor installed in said at least one wheel bracket for detecting the amount and direction of a strain occurred thereon so as to produce a respective strain data indicative of the amount and direction of the strain detected.

2. The intelligent chassis mechanism as claimed in claim 1, wherein said at least one stress-strain sensor each is a strain meter.

3. The intelligent chassis mechanism as claimed in claim 1, wherein said at least one stress-strain sensor each is a piezo meter formed of a piezoelectric crystal.

4. The intelligent chassis mechanism as claimed in claim 1, wherein said at least one stress-strain sensor comprises a Wheatstone bridge circuit that comprises a variable resistor formed of a strain meter.

5. The intelligent chassis mechanism as claimed in claim 4, wherein said Wheatstone bridge circuit further comprises a variable resistor formed of a temperature compensation strain meter and installed in a detecting base that is made of same material as said chassis body.

6. The intelligent chassis mechanism as claimed in claim 1, further comprising a temperature-strain sensor mounted on a detecting base made of same material as said chassis body for providing a strain data for temperature compensation.

7. The intelligent chassis mechanism as claimed in claim 1, wherein said at least one wheel bracket each has at least one of said at least one stress-strain sensor installed therein.

8. The intelligent chassis mechanism as claimed in claim 7, wherein said at least one wheel bracket each has three said stress-strain sensors installed therein and arranged in X, Y and Z directions to form a Cartesian coordinate system.

9. A microprocessor-based intelligent vehicle comprising:
a chassis;
at least one wheel rotatably fastened to said chassis to bear the weight of the intelligent vehicle; and
at least one stress-strain sensor installed in said chassis corresponding to said at least one wheel for detecting the amount and direction of a strain occurred thereon so as to provide a respective strain data indicative of the amount and direction of the strain detected to a microprocessor of the microprocessor-based intelligent vehicle for processing and further display on a display monitor that is electrically connected to the microprocessor of the microprocessor-based intelligent vehicle.

10. The microprocessor-based intelligent vehicle as claimed in claim 9, wherein said at least one stress-strain sensor each is a strain meter.

11. The microprocessor-based intelligent vehicle as claimed in claim 9, wherein said at least one stress-strain sensor is a piezo meter formed of a piezoelectric crystal.

12. The microprocessor-based intelligent vehicle as claimed in claim 9, wherein said at least one stress-strain sensor comprises a Wheatstone bridge circuit that comprises a variable resistor formed of a strain meter.

13. The microprocessor-based intelligent vehicle as claimed in claim 12, wherein said Wheatstone bridge circuit further comprises a variable resistor formed of a temperature compensation strain meter and installed in a detecting base that is made of same material as said chassis.

14. The microprocessor-based intelligent vehicle as claimed in claim 9, further comprising a temperature-strain sensor mounted on a detecting base made of same material as said chassis body for providing a strain data for temperature compensation.

15. The microprocessor-based intelligent vehicle as claimed in claim 9, wherein the number of said at least one stress-strain sensor is equal to or greater than the number of said at least one wheel.

16. The microprocessor-based intelligent vehicle as claimed in claim 15, wherein said at least one wheel bracket each has three said stress-strain sensors installed therein and arranged in X, Y and Z directions to form a Cartesian coordinate system.

17. The microprocessor-based intelligent vehicle as claimed in claim 9, wherein said at least one stress-strain sensor provides the respective strain data to the microprocessor of the microprocessor-based intelligent vehicle by a wireless communication method.

18. The microprocessor-based intelligent vehicle as claimed in claim 9, wherein said at least one stress-strain sensor provides the respective strain data to the microprocessor of the microprocessor-based intelligent vehicle by a wired communication line.
